(19) United States
(12) Patent Application Publication
(10) Pub. No.: US 2007/0111553 A1
(43) Pub. Date: May 17, 2007

(54) Universal integrated circuit programming socket board rewirable by means of an interconnect adapter board

(76) Inventor: Richard Michael Fleck, Scranton, PA (US)

Correspondence Address: Mr. Richard Fleck, Jr., 2301 Golden St., Scranton, PA, 18508-2035, US

(21) Appl. No.: 11/273,225

(22) Filed: Nov. 12, 2005

(51) Int. Cl. H01R 29/00; G06F 17/50

(52) U.S. Cl. 439/43; 716/15

(57) ABSTRACT

A tool for programming integrated circuits which reduces redundancy of parts by making different and multiple programmable integrated circuit sockets of particular sizes and shapes adaptable to more than one programming cable, and therefore many different integrated circuits. By inserting a small interconnect adapter board onto the main programming board, it rewires the main board such that one or more of the included device programming sockets is connected properly to the correct in-system cable connector required by the manufacturer of the particular integrated circuit being programmed. Since the integrated circuit sockets are not permanently wired to a particular programming cable connector, the programming adapter is extremely versatile.

### BACKGROUND OF THE INVENTION

This invention pertains to the field of electrical engineering. The invention is a circuit board containing multiple sockets and multiple programming cable connectors, and an adapter for wiring these sockets to a particular configuration. It is a tool for programming integrated circuits, primarily intended for programming complex programmable logic devices from many manufacturers, but can also be used to program microprocessors and memory. This invention reduces redundancy of parts by making different integrated circuit sockets adaptable to more than one programming cable, and therefore many different integrated circuits.

Usually, programming boards are provided by the manufacturer at a substantial cost. For example, one board usually connects a single model integrated circuit, with its necessary connections permanently wired to an integrated circuit socket, and to a single in-system programming cable, and the manufacturer may have dozens of different programming boards. To program many different types of integrated circuits, one would normally have to buy many programming boards from the manufacturer. The integrated circuit sockets used to program these integrated circuits are of different shapes and pin counts, and of several styles, such as the open-top style, in which spring-loaded conductors make a small contact on the end of a surface-mounted device, or the clamshell style, in which a hinged cover holds in place an integrated circuit resting on conductive metal strips, or of the zero insertion force style.

Each manufacturer has different programmable integrated circuits that can be programmed with the same cable. There may be several different integrated circuits of the same size and shape (Joint Electron Device Engineering Council or JEDEC configuration), although the numbering (position) of the supply voltage, ground, and programmability pins may be different. These integrated circuits of the same JEDEC configuration may be made by the same or different manufacturers.

Several integrated circuits from the same manufacturer, all of which have the same JEDEC configuration, may have different pin arrangements. Conversely, several integrated circuits from different manufacturers may all have a common JEDEC configuration, but many or all must be programmed using different cables.

This invention is primarily an attempt to create a universal adapter which allows for both programming complex programmable logic devices (CPLDs) from different manufacturers before placing and soldering these devices on their final printed circuit boards, and for the capability to quickly move the design to an integrated circuit from another manufacturer before the final circuit board is designed.

### BRIEF SUMMARY OF THE INVENTION

This invention is a tool for programming integrated circuits which reduces redundancy of parts by making different and multiple programmable integrated circuit sockets of particular sizes and shapes adaptable to more than one programming cable, and therefore many different integrated circuits. By inserting a small interconnect adapter board onto the programming board, it allows several integrated circuits which are from the same manufacturer, all of which have the same JEDEC configuration but have different pin arrangements, to be programmed on the same board. It also allows several integrated circuits from different manufacturers that all have a common JEDEC configuration, but must be programmed using different in-system programming cables to be programmed on the same board. Lastly, it allows integrated circuits of more than one JEDEC configuration to be programmed with the same in-system programming cables on the same board. It is intended to be a universal platform for programming surface-mount and through-hole CPLDs which are not yet soldered to their final circuit boards.

### BRIEF DESCRIPTION OF THE DRAWINGS

The drawings illustrate one possible method of implementing the invention.

FIG. 1 is a plan view of the circuit board used to program the target integrated circuits.

FIG. 2 is a perspective view of the adapter circuit board used for one possible interconnection scheme.

### DETAILED DESCRIPTION OF THE INVENTION

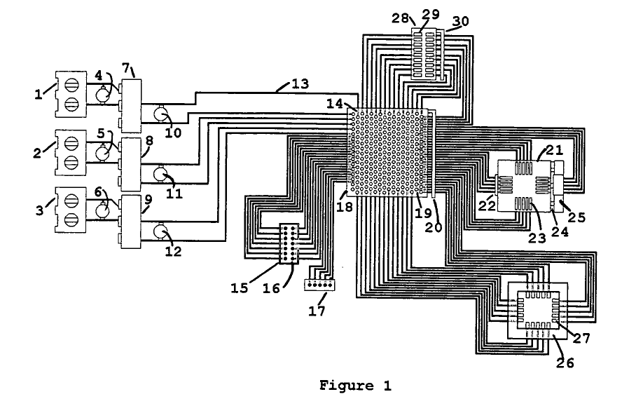

With regard to FIG. 1, a printed circuit board for the programming of programmable integrated circuits, such as microprocessors and complex programmable logic devices is disclosed.

Terminal blocks 1, 2, and 3 are used for connection of direct current (DC) power supply wiring. Capacitors 4, 5, and 6 stabilize the input voltages, which are then connected via circuit board traces to voltage regulators 7, 8, and 9. Each of the voltage regulators provides a separate commonplace device operating voltage, such as 5.0 volts DC for regulator 7, 3.3 volts DC for regulator 8, and 2.5 volts DC for regulator 9. In the actual commercial implementation there may be more terminal blocks and separate voltages. The input voltage levels connected to terminal blocks 1, 2, and 3 depend on the input specifications for regulators 7, 8, and 9, respectively. The output voltages of regulators 7, 8, and 9, are stabilized by capacitors 10, 11, and 12, respectively. These stabilized output voltages are connected via conductive circuit board traces to separate pin receptacles 19 of the zero-insertion force (ZIF) socket 18.

One of the many conductive circuit board traces 13 is noted. Lines of similar width in the drawing are also conductive circuit traces. The path of a conductive circuit trace 14 running beneath a component is depicted using double dotted lines.

An in-system programming connector 15 of the “shrouded header” variety, has all of its conductive pins 16 connected via circuit board traces to separate pin receptacles 19 of the ZIF socket 18. Connector 15 mates an in-system programming cable, available from the manufacturer of the particular programmable integrated circuit contained in one of the target sockets 21, 26 or 28. These in-system programming (ISP) cables connect to a computer for the purpose of transferring information to an integrated circuit.

Likewise, another in-system programming connector 17 of the plain “header” variety and of another wiring configuration and/or compatible with another brand or model of integrated circuit also has all of its conductive pins connected via circuit board traces to separate pin receptacles 19 of the ZIF socket 18.

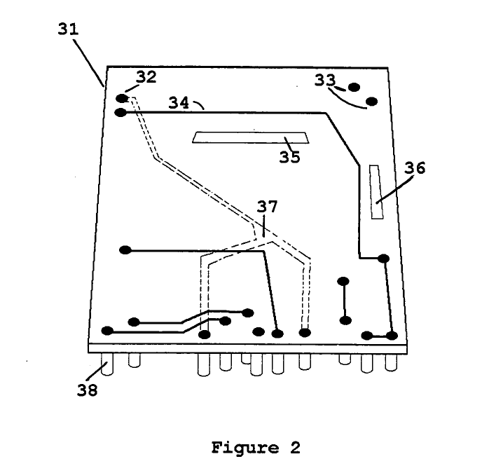

A socket 18 of the ZIF variety is used to hold and connect into the circuit the secondary interconnection circuit board shown in FIG. 2. The ZIF socket contains an array of receptacles 19 which accept the pins contained on the interconnection circuit board 31 of FIG. 2. The ZIF socket is customarily used for connecting an integrated circuit of the pin grid array (PGA) type to a circuit board. In this invention, it is used to connect a small circuit board to the main circuit board. The ZIF socket is operated by raising the lever 20, which loosens the internal contacts to prevent damage to the pins of the device to which it connects, and then placing the interconnection circuit board 31 into the socket, and then lowering the lever, which holds the device firmly in place and makes reliable electrical contact between all of the mating device pins and socket receptacles 19.

A socket 21 of the clamshell variety, with hinged lid, is used to accommodate a programmable integrated circuit of the surface-mount “quad flatpack” style. All conductors of clamshell socket 21 are connected via circuit board traces to separate pin receptacles 19 of the ZIF socket 18. The integrated circuit's leads rest on conductive contacts 23. The socket is operated by placing the integrated circuit on the conductive contacts 23 and then closing the lid 25 which pivots on hinge 24 and is held in place by latch 22. During programming the socket remains closed.

A socket 26 of the open-top variety is used to accommodate another size programmable integrated circuit of the surface-mount “quad flatpack” style. All conductors of open-top socket 26 are connected via circuit board traces to separate pin receptacles 19 of the ZIF socket 18. The integrated circuit's leads are clamped under spring-loaded conductive contacts 27. The socket is operated by holding down the spring-loaded rim of socket 26, which raises slightly the spring-loaded conductive contacts 27, then placing the integrated circuit under the spring-loaded conductive contacts 27 and then releasing the rim until programming is complete.

A socket 28 of the ZIF variety is used to accommodate another size programmable integrated circuit of the dual inline package style. It has conductive receptacles 29 to accept the integrated circuit pins, and is operated in a similar fashion as ZIF socket 18.

FIG. 1 has shown one implementation of the invention. Other implementations may be made in which in-system programming connectors 15 and 16 have different numbers of pins, or different style connectors to mate with a particular manufacturer's in-system programming cable, or there may be more than two in-system programming connectors. Additionally, integrated circuit sockets 21, 26, and 28 which are used for connecting the target programmable devices into the circuit may have different numbers of pins, and/or one or more of the sockets may accommodate a different integrated circuit package style, and there may be any number (one or greater) of integrated circuit sockets for connecting the target programmable devices. The ZIF socket 18 typically has in excess of 300 pins, which makes possible wiring the pins of the target programmable integrated circuits (by means of their sockets and the adapter circuit board of FIG. 2) to the proper supply voltages and programming cable configuration.

FIG. 2 shows a perspective view of one possible interconnection adapter 31. This adapter 31 is a small printed circuit board and mates with ZIF socket 18, and has conductive circuit board traces 34 on its top layer and conductive circuit board traces 37 on its bottom layer. Lines of similar width as 34 also depict conductive circuit traces. Conductor pins 32 as shown from the top and 38 as shown from the underside of adapter 31 are soldered to the printed circuit board. Dots of similar style as 32 and posts of similar style as 38 show other interconnection pins. Conductor pins 33, while not connected to any circuits, serve to align the adapter such that it is oriented properly into ZIF socket 18. Text label 35 shows the purpose of the interconnection adapter 31, such as model number of target programmable device, in-system programming cable type, and target socket style and pin count. Text label 36 shows the model number of the interconnection adapter 31. In the implementation shown, when adapter 31 is mated with ZIF socket 18, in-system programming cable 17 becomes wired to the surface-mount integrated circuit connected in open-top socket 26 and a 3.3 volt DC supply is used.

Other implementations of adapter 31 in FIG. 2 may have the adapter wired to any other possible combination of supply voltage, in-system programming cable, and target device socket or sockets, and this other possible combination may match the implementation shown in FIG. 1 or it may match another conceivable implementation.

What I claim as my inventions are:

1. A circuit board reconfigurable by non-electrical means, as in FIG. 1, for programming programmable integrated circuits, such as complex programmable logic devices, which has:
connectors that mate specifically with more than one manufacturer and/or brand and/or model of programming cable;
and one or more different types or sizes (conductor count) of integrated circuit socket, which can be configured to work with any of the different types of programming cables plugged into the board.

2. The circuit board of claim 1 utilizing the concept of mechanically reconfiguring the electrical connections between components on a larger circuit board to suit a particular wiring arrangement of its components by choosing one secondary, smaller circuit board from a set of mechanically compatible (as in fitting into the same receptacle) smaller circuit boards, each containing wiring for a different particular wiring arrangement of the components of the primary board.

3. A circuit board as in claim 1 and FIG. 1, and its other possible implementations, in which the wiring of the sockets for the target devices is not permanent, thus allowing for rewiring of the socket (and the device contained in the socket) for any possible configuration with the other devices for any purpose necessary.

4. The concept of using one or more secondary, smaller circuit boards to contain interconnections between components on the larger primary circuit board, instead of the typical use of headers with shorting jumpers.

5. The small circuit board of claim 4 and FIG. 2 itself, and its other possible implementations, which contains the interconnections suited to a particular target device and cable and supply voltage combination.

6. The use of an integrated circuit socket to contain a circuit board for interconnection wiring instead of the typical use of the socket to simply contain an integrated circuit.
